(19) United States
(12) Patent Application Publication
(10) Pub. No.: US 2022/0289020 A1
(43) Pub. Date: Sep. 15, 2022

(54) BARRIER FILM-CONTAINING TANK SHELL WITH PERMEATION-SECURE CONNECTOR FORMATION FOR CONNECTING A SEPARATE CONDUIT COMPONENT

(71) Applicant: Röchling Automotive SE & Co. KG, Mannheim (DE)

(72) Inventors: Dieter Kerschbaumer, Tramin (IT); Christoph Ganthaler, Naturns (IT)

(21) Appl. No.: 17/692,541

(22) Filed: Mar. 11, 2022

(30) Foreign Application Priority Data
Mar. 15, 2021 (DE) 10 2021 106 280.2

(51) Int. Cl. B60K 15/03; B60K 15/01

(52) U.S. Cl. CPC B60K 15/03177; B60K 15/01; B60K 2015/03059; B60K 2015/03046; B60K 2015/03447; B60K 2015/03493; B60K 2015/03078

(57) ABSTRACT

A tank shell for a motor vehicle tank, exhibiting a tank shell inner surface facing towards the tank volume surrounded by it and a tank shell outer surface facing away from the tank volume surrounded by it, where a tank shell wall exhibits at least section-wise a multilayer layer structure, where the layer structure having at least one interior wall section produced by injection molding and located nearer to the tank shell inner surface, at least one exterior wall section produced by injection molding and located nearer to the tank shell outer surface, and a barrier film located between the interior wall section and the exterior wall section, where the tank shell wall exhibits at least one aperture penetrating through the tank shell wall along an aperture path, where a section of the barrier film is exposed in the region of the aperture; the section of the barrier film exposed in the region of the aperture is configured integrally with the barrier film in the tank shell wall and for contacting by a sealing arrangement of a conduit component realized separately from the tank shell wall.

This Application claims priority in German Patent Application DE 10 2021 106 280.2 filed on Mar. 15, 2021, which is incorporated by reference herein.

The present invention concerns a tank shell for a motor vehicle tank, where the tank shell exhibits a tank shell inner surface facing towards the tank volume surrounded by it and a tank shell outer surface facing away from the tank volume surrounded by it, where a tank shell wall exhibits at least section-wise a multilayer layer structure, where the layer structure comprises at least one interior wall section produced by injection molding located nearer to the tank shell inner surface, at least one exterior wall section produced by injection molding located nearer to the tank shell outer surface, and a barrier film located between the interior wall section and the exterior wall section, where the tank shell wall exhibits at least one aperture penetrating through the tank shell wall along an aperture path, where a section of the barrier film is exposed in the region of the aperture.

### BACKGROUND OF THE INVENTION

Such a tank shell is known from DE 10 2017 119 706 A1. From such a tank shell, supplemented by at least one further tank shell, there is formed a tank which is especially impermeable with regard to permeation through the tank's wall of fluid accommodated in the tank's volume. The thinking here, as in the present invention, is preferably about the undesirable permeation of hydrocarbons which are contained in motor vehicle fuels. Therefore the tank shell of the present invention is preferably a tank shell for forming a fuel tank of a motor vehicle.

The barrier film known from the state of the art comprises at least one layer from a material which for a predetermined substance is an especially effective permeation barrier. Onto the barrier film there are injected at least locally an interior wall section and an exterior wall section each made from a thermoplastic synthetic, for instance in order to protect the barrier film at the location of the injection from mechanical, and/or chemical effects and/or in order to form with the barrier film a stable structure which is less easily deformable than the barrier film alone, and/or in order to configure by way of injection molding at the tank wall thus formed a functional formation that departs in its shape from a mere planar layer with constant thickness, such as for instance a connector formation for connecting a fluid conduit, an attachment formation for attaching the tank shell and with it the tank formed with it to a supporting structure, a bracing formation for increasing the stiffness of the tank shell, and the like.

Of course, it has to be possible to fill content in a tank and withdraw it again from the same. To this end the tank, and therefore also the tank shell contributing to its formation, exhibit apertures which completely penetrate through the tank wall and/or the tank shell wall respectively. To these apertures there should normally be connected a conduit which is configured to convey a fluid into the tank's volume and/or to convey the fluid out of it.

Since the aperture penetrates through the tank shell wall, the permeation barrier of the barrier film is disrupted at this point. This is desired for the aperture itself, since otherwise fluid could not pass through the aperture.

However, normally the weakening of the permeation barrier created by the aperture extends beyond the edge of the aperture and also affects the regions of the tank shell located near the aperture. In particular when a conduit realized separately from the tank shell is to be connected to the aperture, the region of a connector formation configured at the tank shell is problematic in terms of the barrier effect achievable there.

DE 10 2017 119 706 A1 proposes, for configuring a connector formation such as for instance a nozzle, to form at the tank shell wall a separate piece of barrier film into a conduit section and to bond it with a barrier film section of the tank shell surrounding the aperture. To this end, the barrier film section of the tank shell can be shaped out of the adjacent extension area of the barrier film along the aperture path which penetrates through the aperture. For example, the shaped-out barrier film section can be a stub protruding slightly from the surrounding tank shell wall. The conduit section formed separately with a barrier film can be applied to this shaped-out barrier film section and bonded with the barrier film section. In doing so, the separate conduit section can be bonded with the tank shell by means of an injected interior and/or exterior wall section material only, or the barrier film of the separate conduit section can be welded with the barrier film section of the tank shell.

Bonding through mere injection still does not rule out a permeation gap between the barrier film of the tank shell and the barrier film of the separate conduit section. Welding of the two barrier films from the tank wall and the separate conduit section is not unproblematic, due to the high melting temperature of most barrier film materials, and often does not lead permanently to the desired imperviousness.

### SUMMARY OF THE INVENTION

It is, therefore, the task of the present invention to develop the tank shell mentioned in the beginning in such a way that a separate fluid conduit can be connected to the tank shell in the bonding region between the tank shell and the separate fluid conduit with the highest possible permeation security .

The present invention solves this task in a generic tank shell by having the section of the barrier film exposed in the region of the aperture configured integrally with the barrier film in the tank shell wall and configured for contacting by a sealing arrangement of a conduit component realized separately from the tank shell wall. Thus the exposed section of the barrier film is sufficiently large, such that it can be securely contacted in a sealing manner by a separate, thus structurally not integrally continuous with the tank shell, conduit component. Aside from that, the exposed section is configured integrally continuous with the barrier film of the rest of the tank shell wall. The exposed section is therefore free from joint seams and the like.

The tank shell usually exhibits a complex topology, with locally differently and even oppositely curved tank shell regions. The tank shell is, however, curved overall concavely at its inner surface facing towards the later tank volume, such that it can encircle a part of the tank volume of the tank formed with the involvement of the tank shell. Accordingly, the tank shell is curved overall convexly at its outer surface facing away from the later tank volume. Due to this overall concave tank inner surface, the tank shell can surround a tank volume and/or a part of a tank volume respectively.

The separately realized conduit component can be any arbitrary fluid-conducting component, for instance an elastic hose, a pipe component, or a valve component penetrated through by a conduit. The separately realized conduit component, hereunder also referred to only as a “separate conduit component”, is preferably formed from a material which differs from the material of the interior wall section and/or of the exterior wall section used in the region of the arrangement of the separate conduit component. For example, the separate conduit component can be formed as a hose made of rubber, natural rubber, silicone rubber, a thermoplastic elastomer, or some other elastomer. Likewise, the separate conduit component as a pipe component or valve component can comprise polyamides, polyoxymethylene, blends of polyamide and a polyolefin, in particular polyethylene, and the like. For example, a pipe of the pipe component or a valve housing of the valve component can be formed from one or several of the aforementioned materials.

The sealing arrangement which seals against the exposed section of the barrier film of the tank shell can be configured in various ways. According to a first realization possibility, the sealing arrangement can be a sealing section of the conduit component, which sealing section is configured integrally with the separate conduit component, wherein the sealing section contacts directly the exposed section of the barrier film. This can, for example, be a section of an inner circumferential wall of a hose which is arranged radially outside a connector nozzle configured integrally at the tank shell, where the connector nozzle exhibits a barrier film section exposed radially outwards, and overlaps the connector nozzle axially such that an inner circumferential wall section of the hose can abut in a planar manner on the barrier film section facing radially outward.

The sealing arrangement configured integrally with the separate conduit component can be a blade-shaped sealing projection which protrudes at a pipe component or at a valve component, which with its free blade-shaped end abuts on the barrier film or even intrudes into the latter, especially preferably without penetrating completely through the barrier film. Preferably in the operationally arranged state of the separate conduit component, such a blade-shaped sealing projection proceeds in a closed manner at the tank shell wall around the aperture path, in order to provide a closed sealing path.

Additionally or alternatively, the sealing arrangement can be configured as separate from the conduit component and as separate from the barrier film. The sealing arrangement can then abut with a first abutment section in a sealing manner on a sealing section of the conduit component and with a second abutment section in a sealing manner on the exposed section of the barrier film. The sealing arrangement can comprise one or several sealing rings, for example O-rings. It should expressly not be precluded that in the operational state of the tank shell, the separate conduit component both with a sealing arrangement configured integrally at the conduit component and with a sealing arrangement configured separately from the conduit component, in a sealing manner abuts on the exposed section of the barrier film and/or intrudes into it. The sealing arrangement arranged separately from the conduit component can also protect against leakage of fluid through a gap.

The tank shell does not necessarily have to exhibit the separate conduit component in order to achieve the advantages of the present invention. To this end there suffices the configuration of the barrier film in the region of the aperture described in the present application. Preferably, however, the tank shell exhibits the separate conduit component at the aperture, where the conduit component is sealed against the exposed section of the barrier film.

Depending on the construction of the conduit component, the section of the barrier film exposed in the region of the aperture can be arranged radially outside or radially inside the sealing section of the separate conduit component, relative to the aperture path. As set out above, the exposed section of the barrier film will be situated radially inside the sealing section when the sealing section is formed from an inner circumferential wall section of an elastic hose, to name just one example.

In order to ensure a high permeation barrier effect, the exposed section of the barrier film preferably proceeds along a closed path around the aperture path, so as to provide a closed sealing path with the sealing arrangement.

The exposed section of the barrier film can be configured with a planar shape around the aperture which penetrates through it, for instance when the separate conduit component is to be moved towards and placed onto the exposed section essentially along the aperture path. A planar exposed barrier film section mostly extends transversely or orthogonally to the aperture path. Such a configuration is especially suitable for the blade-shaped sealing section described above, but can also be utilized when using at least one aperture-encircling sealing ring.

In order to be able to configure in an aperture-near region a contactable barrier film section with the largest possible area, regardless of the cross-sectional area of the aperture of the tank shell, the exposed barrier film section can proceed along the aperture path towards the tank volume or away from the tank volume. Preferably when the exposed barrier film section proceeds along the aperture path towards the tank volume, for reasons of strength an injected interior wall section will be provided but no exterior wall section. Along the course of the exposed barrier film section, the interior wall section then preferably encircles the exposed barrier film section radially outside.

In principle, however, it is the case both when the exposed barrier film section proceeds along the aperture path away from the tank volume and when the exposed barrier film section proceeds along the aperture path towards the tank volume, that either an injected interior wall section encircled by the barrier film section radially outside can be configured but no exterior wall section, and then the exposed barrier film section is contactable from radially outside. Or an injected exterior wall section encircling the barrier film section radially outside can be configured but no interior wall section, and then the exposed barrier film section is contactable from radially inside.

The separate conduit component can be placed onto or applied to the tank shell from the outer surface of the latter or can be placed onto or applied to the tank shell from the inner surface of the latter.

A connector formation of the tank shell with the exposed barrier film section for connecting the separate conduit component to the former, whose exposed barrier film section proceeds along the aperture path in one of the two aforementioned directions, surrounds an accommodating space in which a section of the separate conduit component, preferably with an outer shape configured as essentially complementary to the accommodating space, can be accommodated.

In the case of structurally simple configuration of the bonding of the separate conduit component with a connector formation which exhibits the exposed barrier film section, for instance in the case of a hose conduit as the conduit component pushed onto a protruding connector nozzle, a separate securing element, such as for instance a hose clip, can suffice for securing the conduit component to the connector formation. In order to increase the bonding security between the separate conduit component and the connector formation with exposed barrier film section formed at the tank shell, the interior wall section and/or the exterior wall section can exhibit a securing formation. In the case of a hose as the conduit component, this can be realized through at least one radially outward protruding securing projection at the connector nozzle connected with the hose, where a plurality of securing projections can preferably form a known Christmas tree structure. If the separate conduit component is a hose or otherwise an elastic conduit, the securing formation of the tank shell can impress on the elastic conduit its shape in a deforming manner, thus increasing the force required for detaching the separate conduit component from the tank shell.

Preferably the separate conduit component exhibits a securing counter-formation for engaging with the securing formation, where then the securing formation in interaction with the securing counter-formation secures the separate conduit component to the tank shell by means of positive locking and/or firm bonding with an especially high degree of security against detaching.

The separate conduit component can exhibit a conduit extending along a virtual conduit path penetrating through the conduit component, through which fluid can be conducted towards the tank volume and/or away from it through the separate conduit component. The fluid to be conducted through can be a gas or a liquid. In this conduit there can be arranged a valve arrangement, which is switchable between a blocked position and an open position either by means of an actuator or by means of a predetermined pressure difference between the inlet and the outlet side of the valve arrangement. In the blocked position fluid cannot flow through the conduit, in the open position in contrast it can.

The conduit path defines for the following description a local axial direction proceeding along the conduit path, a local radial direction proceeding orthogonally to the conduit path, and a circumferential direction encircling the conduit path. With the separate conduit component arranged operationally at the tank shell, the conduit path and the aperture path essentially coincide in the region of the aperture. The conduit path can be curved or angled and consequently proceed locally in different spatial directions.

In principle, according to an advantageous development of the present invention, the sealing section can comprise the securing counter-formation. Preferably, however, in order to ensure the best possible functional fulfilment, the securing counter-formation is arranged axially and/or radially offset relative to the sealing section. Accordingly, on the part of the tank shell the exposed barrier film section is normally arranged axially and/or radially offset to the securing section. A radially offset, and preferably axially overlapping, arrangement makes possible an axially shorter configuration both of the separate conduit component and of the connector formation at the tank shell. An axially offset, and preferably radially overlapping, arrangement allows in contrast a radially slim configuration of the conduit component and the connector formation.

According to a possible configuration of the anti-detaching device, a formation consisting of a securing formation and a securing counter-formation can exhibit a radial projection which engages behind a rear-engagement surface of the respective other formation in the radial direction, thereby limiting axial removal movement of the separate conduit component in the direction away from the tank shell. Positively locked securing of the separate conduit component to the tank shell can thereby be realized.

Additionally or alternatively, the securing formation can at least section-wise be injected onto the securing counter-formation. A positively locked and/or firmly bonded anti-detaching device can thereby be realized.

The anti-detaching device can be configured to be simply and preferably even detachably producible, if for instance the radial projection is configured as a radially springily displaceable latching projection.

In order to enhance the sealing effect, the section of the barrier film exposed in the region of the aperture can exhibit at least one radial and/or axial step. A radial step here is a step where the course of the exposed section of the barrier film changes from a predominantly axial course to a predominantly radial course, whether towards the aperture path or away from it. Accordingly, an axial step is a step where the course of the exposed section changes from a predominantly radial course to a predominantly axial course, whether towards the tank volume or away from it.

The sealing arrangement of the separate conduit component can abut on the exposed section of the barrier film over several alternating axial and radial steps, thus forming a kind of labyrinth seal between barrier film and conduit component.

The aforementioned accommodating space can be used especially simply and reliably for correct arrangement of the separate conduit component at the tank shell, if the section of the barrier film exposed in the region of the aperture proceeds at least also along the aperture path and preferably tapers along the aperture path. The tapering can be configured as continuous or stepped.

As already described above in connection with the state of the art, preferably the barrier film of the present application is also a multilayer film with at least one bonding layer located on the outside and with at least one functional barrier layer. The functional barrier layer exhibits a specific barrier effect against permeation of hydrocarbons, which under the same permeation conditions is greater than the specific barrier effect of the bonding layer. The specific barrier effect is a barrier effect based on the available permeation area and on the thickness of the functional barrier layer in the permeation area. For a comparison of the barrier effect of different materials in respect of a permeating substance, the same permeation conditions should of course always be set, such as for instance the temperature, the pressure difference between the two sides of the barrier layer, the difference between the concentrations of the permeating substance on the two sides of the barrier layer etc. For the preferred case of a permeation barrier against hydrocarbons, the functional barrier layer preferably comprises EVOH and/or PVOH or the barrier layer preferably consists of EVOH and/or PVOH.

To the functional barrier layer there can be applied LDPE on one or on both sides as an adhesive layer, on which there is arranged in turn HDPE as a bonding layer to the interior wall section and/or exterior wall section preferably likewise made of polyethylene (PE), in particular HDPE. In principle, the barrier film can comprise: A central functional barrier layer, where required an adhesive layer arranged on one or both sides, and on the adhesive layer arranged a bonding layer made of a material which is at least compatible with, preferably identical with, the material of the interior wall section or exterior wall section injected onto it.

In order to enhance the sealing effect, the sealing arrangement can protrude into the barrier film over a part of the thickness of the barrier film, as already elucidated above in the connection with the blade-shaped sealing arrangement. The strongest sealing effect is achieved here if the sealing arrangement protrudes into the functional barrier layer, preferably without penetrating through it completely in the thickness direction.

The present invention concerns furthermore a motor vehicle tank comprising at least two tank shells, where at least one tank shell is configured as described above. Due to the special barrier effect of the barrier film against hydrocarbons, the motor vehicle tank is preferably a fuel tank.

The present invention further concerns a motor vehicle with a previously described motor vehicle tank.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A rough schematic elevation view of a vehicle according to the invention with a tank according to the invention, formed with a first embodiment of a tank shell according to the invention, where the region of an aperture with a conduit component arranged therein is part-sectioned,

FIG. 2 A rough schematic part-sectioned elevation view of a second embodiment of a tank shell according to the invention,

FIG. 3 A rough schematic part-sectioned elevation view of a third embodiment of a tank shell according to the invention,

FIG. 4 A rough schematic part-sectioned elevation view of a fourth embodiment of a tank shell according to the invention,

FIG. 5 The circled section V-V in FIG. 4 in an enlarged depiction,

FIG. 6 A rough schematic part-sectioned elevation view of a fifth embodiment of a tank shell according to the invention, and

FIG. 7 A rough schematic part-sectioned elevation view of a sixth embodiment of a tank shell according to the invention,

### DESCRIPTION OF PREFERRED EMBODIMENTS

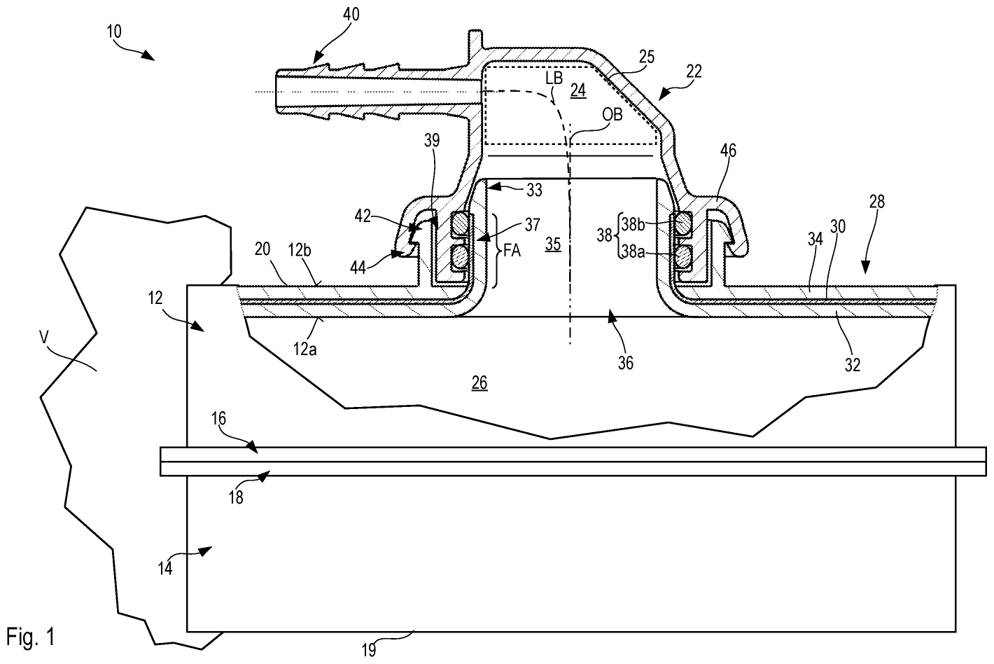

Referring now to the drawings wherein the showings are for the purpose of illustrating preferred and alternative embodiments of the invention only and not for the purpose of limiting the same, in FIG. 1, a tank according to the invention, for example a fuel tank, is depicted in rough schematic form and labeled generally by 10. The tank 10 is installed in a vehicle V which is indicated only symbolically and is carried along with it. The tank 10 comprises a preferably injection-molded upper tank shell 12 and a likewise preferably injection-molded lower tank shell 14, which are bonded with one another along their encircling flanges 16 and/or 18 respectively, for example welded with one another by mirror or ultrasound welding.

At the upper tank shell 12 there is arranged in the tank top 20 located opposite the tank bottom 19 a conduit component 22 formed separately from the tank shell 12, in such a way that a fluid conduit 24 configured in the conduit component 22 reaches into the interior 26 of the tank 10, which is surrounded section-wise by the concave inner surface 12a of the upper tank shell 12. For clearer exposition, the conduit component 22 and the section of the tank shell 12 accommodating it are depicted over-proportionally large.

In the fluid conduit 24 of the conduit component 22 there can be arranged a valve arrangement 25, in order to enable or block the flow through the fluid conduit 24 depending on parameters such as a pressure difference between the two sides of the valve arrangement 25, or depending on control commands of a control device of the motor vehicle V.

The tank wall 28 of the tank 10 comprises a preferably thermoformed barrier film 30 with a PVOH or EVOH layer as a barrier layer against permeation of hydrocarbons, and comprises an interior wall section 32 injected onto the side of the barrier film 30 nearer to the interior and an exterior wall section 34 injected onto the side of the barrier film 30 further from the interior. Preferably both the interior wall section 32 and the exterior wall section 34 are made from HDPE. On the barrier layer of the barrier film 30 there can be arranged on each side of the EVOH layer an LDPE adhesive layer and on it an HDPE layer, which makes possible permanently firm bonding of the interior wall section 32 and the exterior wall section 34 with the barrier film 30.

An exposed area of the interior wall section 32 forms the tank shell inner surface 12a of the tank shell 12. An exposed area of the exterior wall sections 34 forms a tank shell outer surface 12b of the tank shell 12.

An aperture 36 penetrates completely the tank wall 28 in the tank top 20 along a aperture path OB which is straight in the depicted example, thus rendering the interior 26 accessible from the outside.

The barrier film 30 extends in the region of the aperture 36 together with the interior wall section 32 along the aperture path OB chimney-like outwards away from the interior 26 of the tank 10. In this region, the interior wall section 32 covers the barrier film 30 radially inwards towards the aperture path OB, whereas the barrier film 30 is exposed radially outwards relative to the aperture path OB along a section FA. No material of the exterior wall section 34 is provided there. The exposed section FA proceeds in a closed manner around the aperture path OB, thus forming a cylindrical and/or conical sheath surface which surrounds an accommodating space 35.

A pipe section 33 formed in the first embodiment by the interior wall section 32 extends axially relative to the aperture path OB beyond the protruding end of the barrier film 30 and preferably also projects radially over the axial end face of the barrier film 30 and covers it, such that in fact only the side of the barrier film 30 facing radially outwards is exposed in the section FA in which no exterior wall section 34 is provided. Due to the covering of the barrier film 30 by means of the pipe section 33 of the interior wall section 32 on the radially inner side and at the axial end face of the axial end of the pipe attachment 37 formed by the barrier film, very good bonding of the barrier film 30 with the interior wall section 32 is achieved and a delamination tendency in the region of the axially projecting longitudinal end of the pipe attachment 37 formed by the barrier film 30 is decreased.

In the exposed section FA there abuts on the barrier film 30 a sealing arrangement 38, comprising two O-rings 38a and 38b, preferably of the same shape and/or material, arranged one behind the other with coaxial central axes. Due to the direct abutting of the sealing arrangement 38 on the barrier film 30, very high permeation protection against permeation of hydrocarbons is achieved since both the barrier layer of the barrier film 30 and the material of the O-rings 38a and 38b are difficult for hydrocarbons to penetrate through, whereas the polyethylene of the interior and exterior wall sections 32 and/or 34 respectively offers comparatively little to no resistance to permeation of hydrocarbons.

The sealing arrangement 38, which abuts radially inside on the barrier film 30, abuts at its opposite radially outer side on a sealing section 39 of the conduit component 22.

The conduit component 22 is made from a material incompatible with the polyolefin of the interior and exterior wall sections 32 and/or 34 respectively, for example from a polyamide, a polyoxymethylene, a blend of polyamides and a polyolefin, in particular polyethylene, and the like, such that the conduit component is not or only inadequately weldable with the tank shell 12.

The conduit component 22 exhibits a hose connector 40 with a Christmas tree structure directed radially outward, which should hamper removal of a hose pushed onto the hose connector 40.

The fluid conduit 24 penetrates completely through the conduit component 22 along a curved conduit path LB, which in the fully assembled state of the conduit component 22 coincides with the aperture path OB in the region of the aperture 36.

In order to mount the conduit component 22 on the tank shell 12, the conduit component 22 is brought near the aperture 36 from outside along the aperture path OB and the sealing arrangement 38 pushed over the exposed section FA of the barrier film 30, such that the sealing arrangement 38 completely encircles the barrier film 30 in the exposed section FA radially outside.

In order to secure the conduit component 22, there is configured at the exterior wall section 34 a securing formation 42 projecting outward, i.e. away from the interior 26 of the tank 10, which is engaged from behind with positive locking by a securing counter-formation 44 on the conduit component 22. To this end, the securing formation 42 and the securing counter-formation 44 exhibit in the aperture-near section relative to the aperture path OB and/or the conduit path LB respectively appropriate rear-engagement projections facing in radially opposite directions.

The securing counter-formation 44 is configured at the outer end of a radial projection 46 encircling the conduit path LB preferably in a closed manner, which is configured integrally with the conduit component 22, projects radially from the main body of the latter, and with increasing radial distance from the main body takes on an additional axial extension component towards the tank shell-near longitudinal end of the conduit component 22.

In the depicted example, at the conduit component 22 there are arranged the sealing section 39 encircling the conduit path LB in a closed manner and the securing counter-formation 44 axially overlapping and radially offset to one another relative to the conduit path LB. This makes possible the configuration of an axially short conduit component 22, which nevertheless can be mounted securely and with a high permeation barrier on the aperture 36 of the tank shell 12.

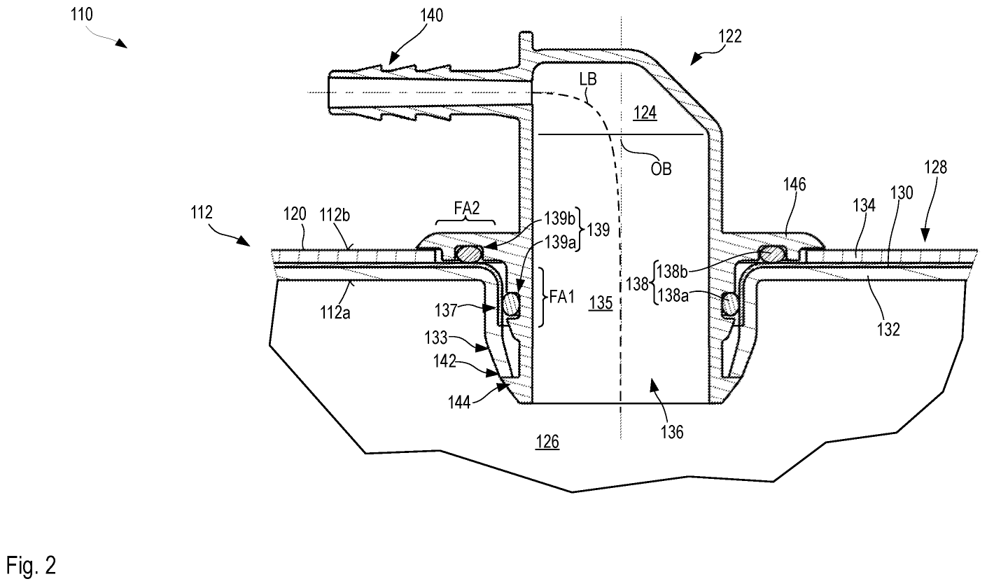

FIG. 2 depicts a second embodiment of the tank shell according to the invention. Identical and functionally identical components and component sections as in the first embodiment are labeled in the second embodiment with the same reference labels, however in the numerical range from 100 to 199. The second embodiment shall be described hereunder only in so far as it differs from the previously described first embodiment, to whose description otherwise reference is made also for elucidating the second embodiment.

The second embodiment of an upper tank shell 112 differs from the first inter alia in that the exposed section FA of the barrier film 130 exhibits an axial section FA1 proceeding along the aperture axis OB and a radial section FA2 proceeding orthogonally to the aperture axis OB. The axial section FA1 surrounds, as in the first embodiment, an accommodating space 135 which in the second embodiment extends into the interior 126 of the tank 110.

Once again the separate conduit component 122 is brought near the tank shell 112 from outside during the assembly, where in contrast to the first embodiment a section of the conduit component 122 is accommodated in the accommodating space 135 and is encircled radially outside by the axial exposed section FA1 of the barrier film 130.

In contrast to the first embodiment, the securing formation 142 is not configured specifically at a wall section injected on, but rather is formed by the free longitudinal end of the pipe section 133 formed by the interior wall section 132 and jutting axially and radially beyond the axial exposed section FA1. In order to increase its form stability, the axial end of the pipe section 133 is configured as tapered outside and inside.

The securing counter-formation 144 is configured integrally with the part of the conduit component 122 forming the fluid conduit 124, namely at its longitudinal end which in the assembled state is nearest to the tank's interior space 126. In order to facilitate the arrangement of the conduit component 122 in the operational position shown in FIG. 2, the radial outer surface of the securing counter-formation 144 is configured as a lead-in chamfer tapered towards the longitudinal end of the conduit component 122.

As in the first embodiment, the sealing arrangement 138 comprises two O-rings 138a and 138b, of which the sealing ring 138a abuts on the axial exposed section FA1 in a sealing manner and of which the sealing ring 138b abuts on the radial exposed section FA2 in a sealing manner. Accordingly, the sealing section 139 of the conduit component 122 is also divided into a axial sealing section portion 139a and a radial sealing section portion 139b.

The securing counter-formation 144 is therefore arranged offset axially to the sealing section 139 and overlapping with it radially, in particular overlapping with the axial sealing section portion 139a.

The sealing ring 138b is accommodated in an accommodating groove, whose groove base forms the radial sealing section portion 139b and which is configured at the radial projection 146, which at its radial projecting end overlaps the exterior wall section 134 protectively. The radial projection 146 proceeds preferably in a closed manner around the conduit path LB and forms a disc-like radial projection 146. Likewise, the radial exposed section FA2 proceeds in a closed manner around the aperture 136.

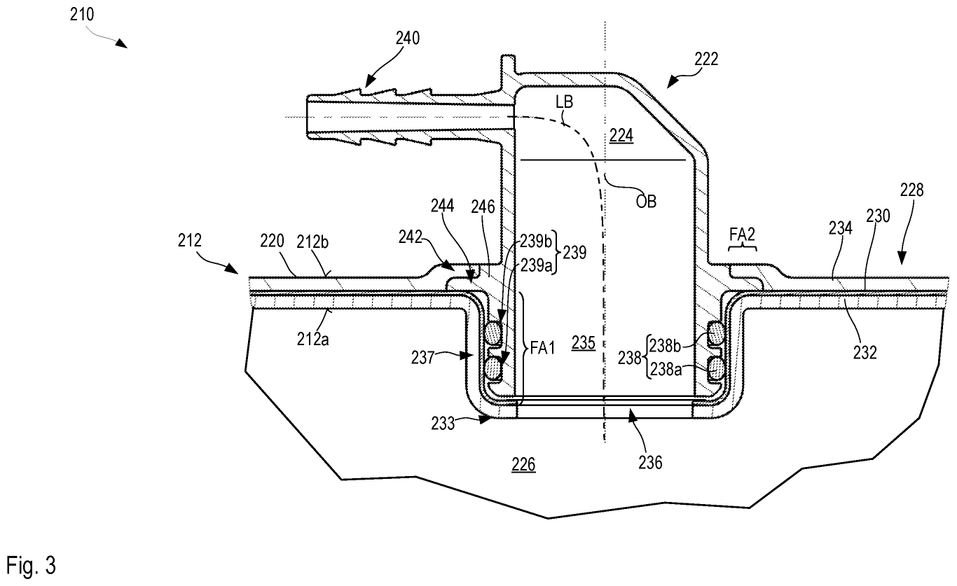

FIG. 3 depicts a third embodiment of the tank shell according to the invention. Identical and functionally identical components and component sections as in the first and the second embodiment are in the third embodiment labeled with the same reference labels, however in the numerical range from 200 to 299. The third embodiment shall be described hereunder only in so far as it differs from the previously described embodiments, to whose descriptions otherwise reference is made also for elucidating the third embodiment.

As in the second embodiment, in the third embodiment the pipe section 233 of the interior wall section 232 and the pipe attachment 237 of the barrier film 230 project from the tank wall 228 towards the tank's interior space 226. The pipe section 233 of the interior wall section 232 does not jut beyond the longitudinal end of the pipe attachment 237 of the barrier film 230, but instead extends together with it and parallel to it.

The sealing arrangement 238 corresponds essentially to the sealing arrangement 38 of the first embodiment, with the difference that the two sealing rings 238a and 238b of the sealing arrangement 238 abut radially outward in a sealing manner against the pipe attachment 237 of the barrier film 230 in the axial exposed section FA1 and radially inward against the sealing arrangement 239 of the conduit component 222.

The encircling radial projection 246 abuts on the radial exposed section FA2 of the barrier film 230, whereby the position of the conduit component 222 relative to the tank shell 212 is defined axially in respect of the aperture path OB.

The radial projection 246 exhibits an axially thicker section located radially further inside and an axially thinner section located radially further outside, where the latter forms the securing counter-formation 244. In the embodiment example of FIG. 3, the securing counter-formation 244 has material of the exterior wall section 234 injected onto it, and/or respectively material of the exterior wall section 234 is injected onto the securing counter-formation 244. The bonding between the conduit component 222 and the tank shell 212 is, therefore, produced by injection molding and is not detachable non-destructively. The section overlapping the securing counter-formation 244 as a securing formation 242 is preferably arranged axially flush with the axially thicker section of the disc-like radial projection 246 located radially further inside.

The pipe attachment 237 and likewise the pipe section 233 encircle the free longitudinal end of the section of the conduit component 222 accommodated in the accommodating space 235 and overlap this longitudinal end radially. The longitudinal end of the conduit component 122 is, therefore, faced in the axial direction by a section of the barrier film 230 and of the interior wall section 232.

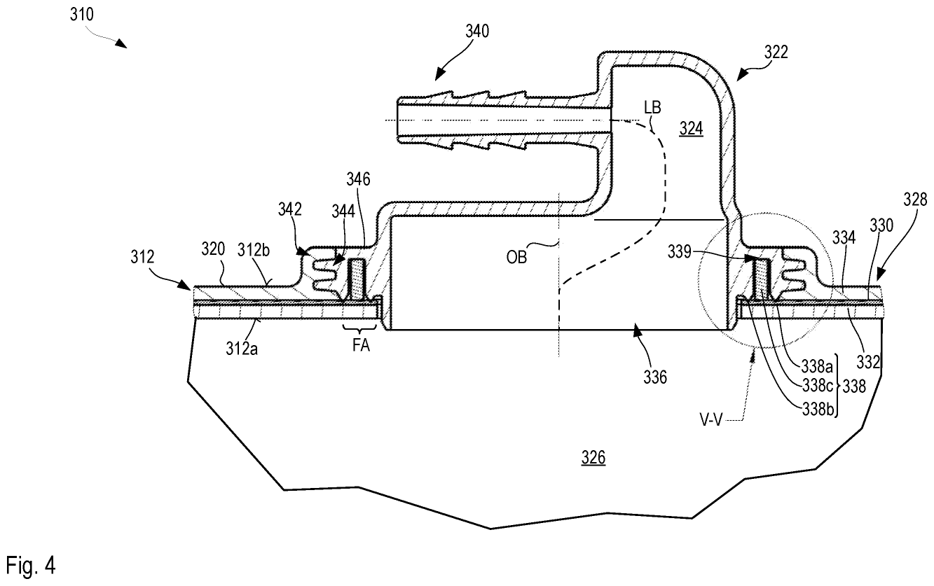

FIG. 4 depicts a fourth embodiment of the tank shell according to the invention. Identical and functionally identical components and component sections as in the preceding first to third embodiments are labeled in the fourth embodiment with the same reference labels, however in the numerical range from 300 to 399. The fourth embodiment shall be described hereunder only in so far as it differs from the previously described embodiments, to whose descriptions otherwise reference is made also for elucidating the fourth embodiment.

In the fourth embodiment according to FIG. 4, only a radially proceeding section FA of the barrier film 330 is exposed. The aperture 336 of the tank shell 312 is not surrounded by any pipe attachment of the barrier film or pipe section of the interior wall section.

Aside from the fact that the fluid conduit 324 widens in the direction from the hose connector 340 to the tank shell-near longitudinal end of the conduit component 322, the conduit component 322 also exhibits an encircling disc-like radial projection 346.

The radial projection 346 serves both for attaching the conduit component 322 to the tank shell 312 and for sealing the conduit component 322 to the barrier film 330. As in the third embodiment, in the fourth embodiment being discussed here too, material of the exterior wall section 334 is injected as a securing formation 342 onto a radial projection formation at the radial projection 346 as the securing counter-formation 344.

The sealing arrangement 338 of the fourth embodiment comprises two encircling blade-shaped seals 338a and 338b configured integrally with the radial projection 346 and comprises additionally an elastomeric seal 338c arranged radially between the blade-shaped seals 338a and 338b, which is inserted as a separate sealing component, more precisely: sealing ring, in a groove which is configured radially between the blade-shaped seals 338a and 338b at the radial projection 346.

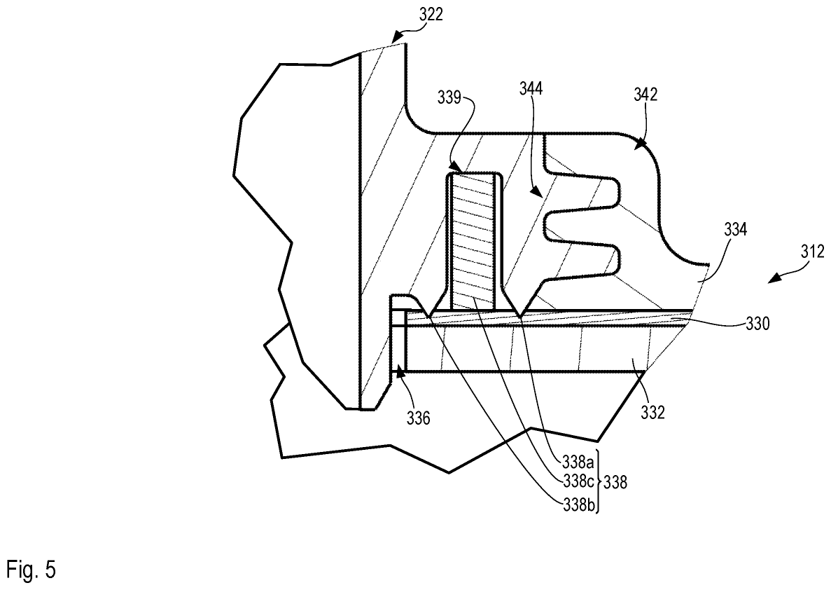

The attachment of the sealing component 322 to the tank shell 312 and its sealing are shown in greater detail in FIG. 5.

As can be discerned in FIG. 5, the securing counter-formation 344 exhibits at least one radial projection, in the depicted example two encircling radial projections, configured essentially uniformy, arranged axially at a distance from one another, where the material injected as the securing formation 342 meshes with the radial projections of the securing counter-formation 344. This means that the securing formation 342 exhibits several, in the depicted example: three, encircling radial projections located axially one above the other, protruding radially inward, of which the top one is located above the top radial projection of the securing counter-formation 344, the middle one between the two radial projections of the securing counter-formation 344, and the bottom one below the bottom radial projection of the securing counter-formation 344.

The securing formation 342 and the securing counter-formation 344 have flush outer surfaces facing outwards in the axial direction.

As can further be discerned in FIG. 5, the blade-shaped seals 338a and 338b extend in the thickness direction of the barrier film 330, i.e. in the axial direction, into the barrier film 330, but do not penetrate through it completely. As a result, the blade-shaped seals 338a and 338b penetrate through adhesive and bonding layers which are preferably present at the barrier film 330 without an appreciable barrier effect, and extend into the actual functional barrier layer of EVOH or PVOH. Hereby a minimal permeation path along the adhesive and/or bonding layers is also interrupted, which can exist with sealing components merely abutting on the barrier film 330, as for instance the elastomeric sealing component 338c or the aforementioned O-rings. The combination of blade-shaped intruding seals and abutting elastomeric seals achieves here an especially total barrier consisting of permeation barrier and fluid barrier. Through increasing and/or variable thermal stressing of the bonding region of the tank shell 312 and the conduit component 322, there could over time arise locally a gap between the outer surface of the tank shell 312 and the radial projection 346, through which tank content in fluid form can migrate from the tank's interior space 326 outwards. The sealing component 338c is a fluid barrier against the leakage of fluid content from the tank. The same applies to the previously and subsequently described elastomeric sealing rings.

The blade-shaped seal 338a located radially further outside forms besides a cavity wall for the material of the exterior wall section 334 injected for forming the securing formation 342.

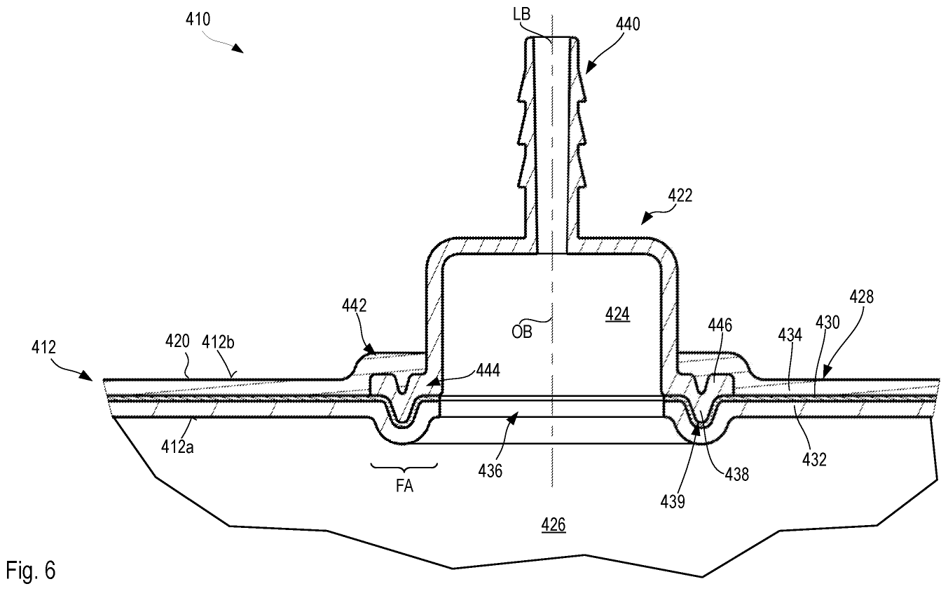

FIG. 6 depicts a fifth embodiment of the tank shell according to the invention. Identical and functionally identical components and component sections as in the preceding first to fourth embodiments are labeled in the fifth embodiment with the same reference labels, however in the numerical range from 400 to 499. The fifth embodiment shall be described hereunder only in so far as it differs from the previously described embodiments, to whose descriptions otherwise reference is made also for elucidating the fifth embodiment.

The fifth embodiment of the tank shell 412 too, like the preceding fourth embodiment, exhibits no accommodating space in the region of the aperture 436 of the tank wall 428 defined by the barrier film 430, the interior wall section 432, or the exterior wall section 434.

Once again the securing formation 442 is created by injection onto an encircling radial projection 446. In the radial projection 446 there is configured an encircling axial groove as the securing counter-formation 444, which is filled up by material of the securing formation 442. The securing formation 442 of the exterior wall section 434 extends radially up to the main body of the conduit component 422 defining the fluid conduit 424 and touches it.

The sealing arrangement 438 is configured integrally with the encircling radial projection 446 as an encircling, axially protruding projection. Unlike the fourth embodiment, the encircling axially protruding projection of the sealing arrangement 438 is not blade-like but instead blunt in configuration, such that it does not intrude into the barrier film 430 but instead abuts on the latter in a planar manner at the radial projection 446 and its axial projection, thus forming a labyrinth seal.

The interior wall section 432 likewise follows in the region of the sealing arrangement 438 the course of the axial projection of the conduit component 422.

A further difference to the previously discussed embodiments consists in the hose connector 440 proceeding along the aperture path OB, such that the conduit path LB defined by the conduit component 422 and the aperture path OB are coaxial straight paths.

In order to form a fluid barrier also, there can be arranged between the radial projection 446 and the securing formation 442 and/or between the radial projection 446 and the barrier film 430 at least one separately configured elastomeric seal, for instance a sealing ring.

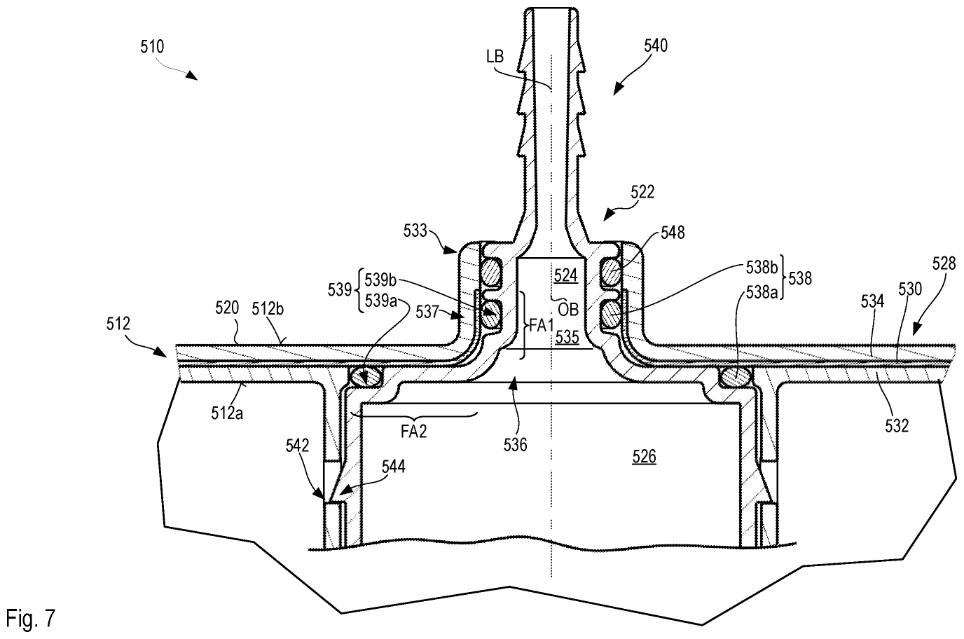

FIG. 7 depicts a sixth embodiment of the tank shell according to the invention. Identical and functionally identical components and component sections as in the preceding first to fifth embodiments are in the sixth embodiment labeled with the same reference labels, however in the numerical range from 500 to 599. The sixth embodiment shall be described hereunder only in so far as it differs from the previously described embodiments, to whose descriptions otherwise reference is made also for elucidating the sixth embodiment.

As in the first embodiment, the pipe attachment 537 of the barrier film 530 and the pipe section 533, this time however of the exterior wall section 534, project outwards in the direction from the tank's interior space 526 away from the tank wall 528.

In order to enhance delamination security, the pipe section 533 of the exterior wall section 534 juts beyond the pipe attachment 537 axially and radially, such that in fact only the area of the barrier film 530 facing towards the tank's interior space 526 and/or towards the aperture path OB respectively is exposed.

As in the second embodiment, a part of the conduit component 522 is accommodated in the accommodating space 535 and encircled radially outside by the pipe attachment 537 and by the pipe section 533.

Like the second embodiment, the sealing arrangement 538 exhibits two sealing rings (O-rings) 538a and 538b, of which the former seals against a radially exposed section FA2 of the barrier film 530 and of which the latter seals against an axially exposed section FA1 of the barrier film 530. As in the second embodiment, the sealing rings 538a and 538b exhibit different diameters and are arranged at an axial distance from one another. Each sealing ring 538a and 538b seals on its side opposite the barrier film 530 against a portion of the sealing section 539 of the conduit component 522. The sealing rings 538a and 538b are permeation and fluid barriers.

At the conduit component 522 there is furthermore arranged a third sealing 548 in the form of a further O-ring, which seals on the one hand against the sealing component 522 and on the other against the pipe section 533 of the exterior wall section 534. The third O-ring 548 and the O-ring 538b can exhibit the same shape and can be formed from the same or from different sealing materials. The third O-ring 548 forms a further fluid barrier against leakage of fluid tank content through gaps between the tank shell 512 and the conduit component 522.

Similarly to the first embodiment, a securing formation 542 axial projects from a wall section, this time however from the interior wall section 532. The securing formation 542 exhibits a recess in which latching lugs engage with positive locking as securing counter-formations 544.

Whereas all the previously discussed embodiments show a conduit component approaching the respective tank shell from outside during assembly, the conduit component 522 of the sixth embodiment approaches the tank wall 528 from inside, i.e. coming from the tank's interior space 526, for mounting on the tank shell 512, until the latching of the securing formation 542 and the securing counter-formation 544 occurs.

The drawings described by way of example an upper tank shell as the tank shell of the present invention. Additionally or alternatively, the conduit arrangement could be arranged at a lower tank shell.

In the individual embodiments, the configurations of the respective sealing arrangement and of the securing formation and securing counter-formation are combined only randomly. The securing formation and securing counter-formation of an embodiment can also be combined with a sealing arrangement of another embodiment. The conduit component can carry a valve arrangement and/or can exhibit a different conduit connector than the depicted hose connector.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A tank shell for a motor vehicle tank which exhibits a tank shell inner surface facing towards the tank volume surrounded by it and a tank shell outer surface facing away from the tank volume surrounded by it, where a tank shell wall exhibits at least section-wise a multilayer layer structure, where the layer structure comprises at least one interior wall section produced by injection molding, located nearer to the tank shell inner surface, at least one exterior wall section produced by injection molding, located nearer to the tank shell outer surface, and a barrier film located between the interior wall section and the exterior wall section, where the tank shell wall exhibits at least one aperture penetrating through the tank shell wall along an aperture path, where a section of the barrier film is exposed in the region of the aperture, wherein the section of the barrier film exposed in the region of the aperture is configured integrally with the barrier film in the tank shell wall and for contacting by a sealing arrangement of a conduit component realized separately from the tank shell wall.

17. The tank shell according to claim 16, wherein the sealing arrangement is a sealing section of the conduit component, said sealing section being configured integrally with the separate conduit component, wherein the sealing section contacts directly the exposed section of the barrier film.

18. The tank shell according to claim 17, wherein the sealing arrangement is configured separately from the conduit component and separately from the barrier film and abuts with a first abutment section in a sealing manner on a sealing section of the conduit component and with a second abutment section in a sealing manner on the exposed section of the barrier film.

19. The tank shell according to claim 16, wherein the sealing arrangement is configured separately from the conduit component and separately from the barrier film and abuts with a first abutment section in a sealing manner on a sealing section of the conduit component and with a second abutment section in a sealing manner on the exposed section of the barrier film.

20. The tank shell according to claim 19, wherein the section of the barrier film exposed in the region of the aperture is arranged radially outside or radially inside the sealing section of the separate conduit component.

21. The tank shell according to claim 17, wherein the section of the barrier film exposed in the region of the aperture is arranged radially outside or radially inside the sealing section of the separate conduit component.

22. The tank shell according to claim 16, wherein the interior wall section and/or the exterior wall section exhibits and/or exhibit respectively a securing formation, and that the separate conduit component exhibits a securing counter-formation, where the securing formation in interaction with the securing counter-formation secures the separate conduit component to the tank shell by means of positive locking and/or firm bonding against detaching.

23. The tank shell according to claim 22, wherein the separate conduit component exhibits a conduit extending along a virtual conduit path, penetrating through the conduit component, where the conduit path defines an axial direction proceeding along the conduit path, a radial direction proceeding orthogonally to the conduit path, and a circumferential direction encircling the conduit path, where the securing counter-formation is arranged offset axially and/or radially relative to the sealing section.

24. The tank shell according to claim 23, wherein a formation consisting of a securing formation and a securing counter-formation exhibits a radial projection which engages behind a rear-engagement surface of the respective other formation in the radial direction, thereby limiting axial removal movement of the separate conduit component in the direction away from the tank shell.

25. The tank shell according to claim 22, wherein a formation consisting of a securing formation and a securing counter-formation exhibits a radial projection which engages behind a rear-engagement surface of the respective other formation in the radial direction, thereby limiting axial removal movement of the separate conduit component in the direction away from the tank shell.

26. The tank shell according to one of the claim 24, wherein the securing formation at least section-wise is injected onto the securing counter-formation.

27. The tank shell according to claim 24, wherein the radial projection is configured as a radially springily displaceable latching projection.

28. The tank shell according to claim 16, wherein the section of the barrier film exposed in the region of the aperture exhibits at least one radial and/or axial step.

29. The tank shell according to claim 16, wherein the section of the barrier film exposed in the region of the aperture proceeds at least also along the aperture path and preferably tapers along the aperture path.

30. The tank shell according to claim 16, wherein the barrier film is a multilayer film with at least one bonding layer located on the outside and with at least one functional barrier layer, whose specific barrier effect against permeation of hydrocarbons under the same permeation conditions is greater than the barrier effect of the bonding layer, where the functional barrier layer preferably comprises EVOH and/or PVOH or consists of EVOH and/or PVOH.

31. The tank shell according to claim 17, wherein the sealing arrangement protrudes into the barrier film over at least part of the thickness of the barrier film.

32. The tank shell according to claim 18, wherein the sealing arrangement protrudes into the barrier film over at least part of the thickness of the barrier film.

33. The tank shell according to the claim 30, wherein the sealing arrangement protrudes into the barrier film over at least part of the thickness of the barrier film, and wherein the sealing arrangement protrudes into the functional barrier layer.

34. A motor vehicle tank, in particular fuel tank, comprising at least two tank shells,

16. least one tank shell, is configured according to claim 16.
